(19) United States
(12) Patent Application Publication
(10) Pub. No.: US 2011/0215975 A1
(43) Pub. Date: Sep. 8, 2011

(54) SATELLITE ANTENNA CONNECTION

(75) Inventor: John Clark Roberts, Cedar Hills, UT (US)

(73) Assignee: Digi International Inc., Minnetonka, MN (US)

(21) Appl. No.: 12/716,657

(22) Filed: Mar. 3, 2010

(51) Int. Cl. H01Q 1/28; H01Q 1/42

(52) U.S. Cl. 343/705

(57) ABSTRACT

An example satellite assembly includes a cover and an antenna attached to the cover. The satellite assembly further includes a base and a satellite module attached to the base such that the antenna is connected to the satellite module when the cover is secured to the base to form a sealed enclosure.

### BACKGROUND

Some example embodiments relate to a satellite assembly that includes an antenna which is connected to a satellite module within a sealed enclosure without using an RF cable. The antennas in prior art satellite assemblies are typically connected to a satellite module using a radio frequency (RF) cable.

One drawback with connecting an antenna to a satellite module using an RF cable is that RF cables are difficult to manufacture to adequate length tolerances, and tuned satellite antennas are very sensitive to cable length variations. If an RF cable that is used to connect an antenna deviates too much in length, unacceptably poor reception can result.

Another drawback with connecting an antenna to a satellite module using an RF cable is that it is typically not possible to secure an RF cable to the antenna and/or the satellite module unless the enclosure that contains the antenna and the satellite module is open. Therefore, the RF cable is usually loose within and a “loose” RF cable moves with any external vibration of the satellite assembly. The movement of the RF cable that is caused by the vibration may cause “tuning” problems with the antenna.

### BRIEF DESCRIPTION OF THE DRAWINGS

FIG. 1 illustrates an example satellite assembly with the enclosure of the satellite assembly closed.

FIG. 2 illustrates an example satellite assembly with the enclosure of the satellite assembly open.

FIG. 3 illustrates an example base and satellite module that may be used in satellite assembly shown in FIGS. 1 and 2.

FIG. 4 illustrates an example cover and antenna that may be used in satellite assembly shown in FIGS. 1 and 2.

FIG. 5 illustrates an example connector that may be used with the antenna shown in FIG. 4.

FIG. 6 illustrates an example connector that may be used with the satellite module shown in FIG. 3.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, electrical, and optical changes may be made without departing from the scope of the present invention. The following description of example embodiments is, therefore, not to be taken in a limited sense, and the scope of the present invention is defined by the appended claims.

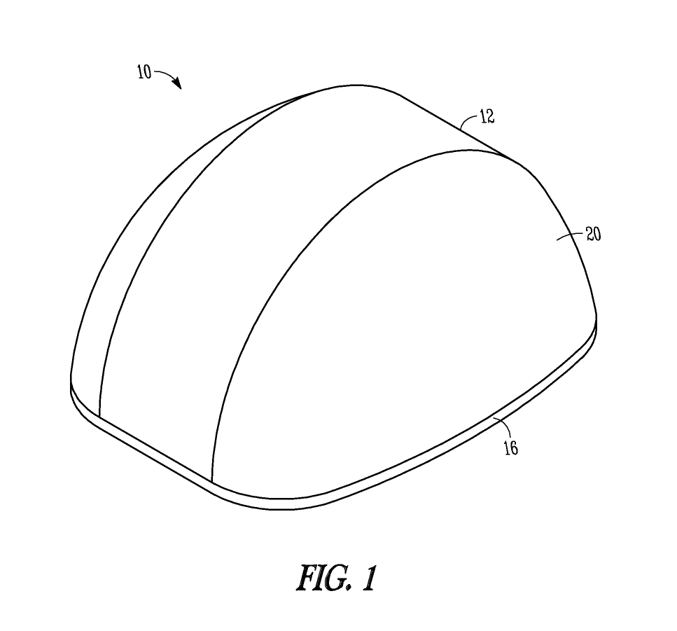

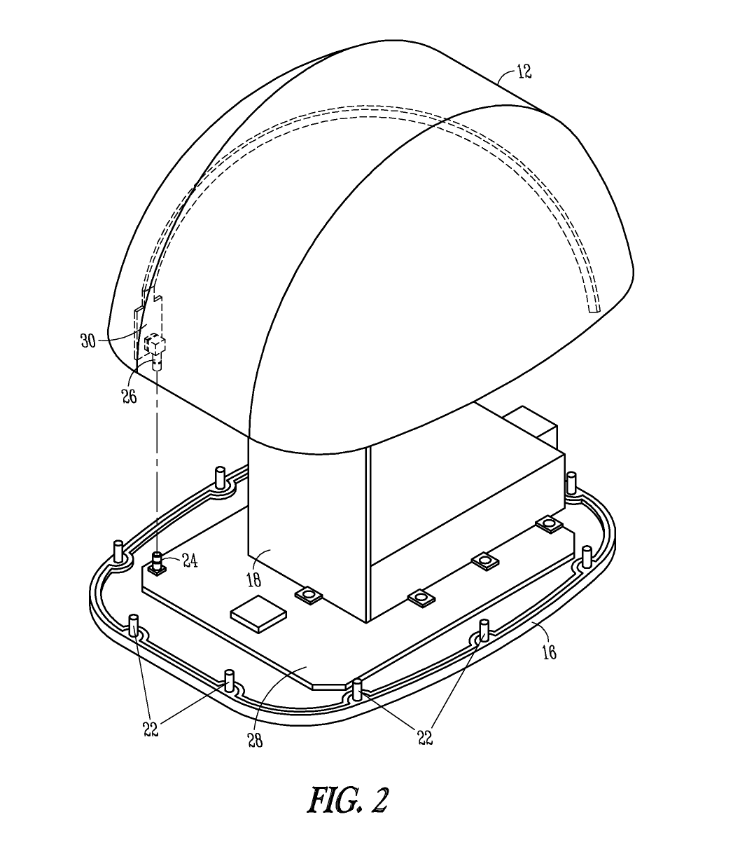

FIGS. 1-2 show all or part of an example satellite assembly 10. The satellite assembly 10 includes a cover 12 and an antenna 14 attached to the cover 12. The satellite assembly 10 further includes a base 16 and a satellite module 18 attached to the base 16 such that the antenna 14 is connected to the satellite module 18 when the cover 12 is secured to the base 16 to form a sealed enclosure 20.

The direct connection between the antenna 14 and the satellite module 18 (i) eliminates the need for a traditional RF cable; (ii) improves manufacturability by eliminating the need to plug a cable into two connectors; and (iii) provides a more precisely tuned antenna due to relatively easy control of antenna and trace lengths.

In some embodiments, the cover 12 is snapped to the base 16. It should be noted that other embodiments are contemplated where the cover 12 and base 16 are secured together by other means.

The antenna 14 may be secured to the cover 12 with an adhesive (not shown). It should be noted that other embodiments are contemplated where the cover 12 and base 16 are secured together by other means.

In addition, the base 16 may be secured to the satellite module 18 with fasteners 22. The manner in which the satellite module 18 is secured to the base 16 will depend in large part upon manufacturing considerations that are associated with fabricating the satellite assembly 10.

In the illustrated example embodiment, the antenna 14 includes a first RF connector 26 and the satellite module 18 includes a second RF connector 24 that is connected to the first RF connector 26. As examples, the first RF connector 26 may be a SMB RF connector and the second RF connector 24 may be a SMB RF connector.

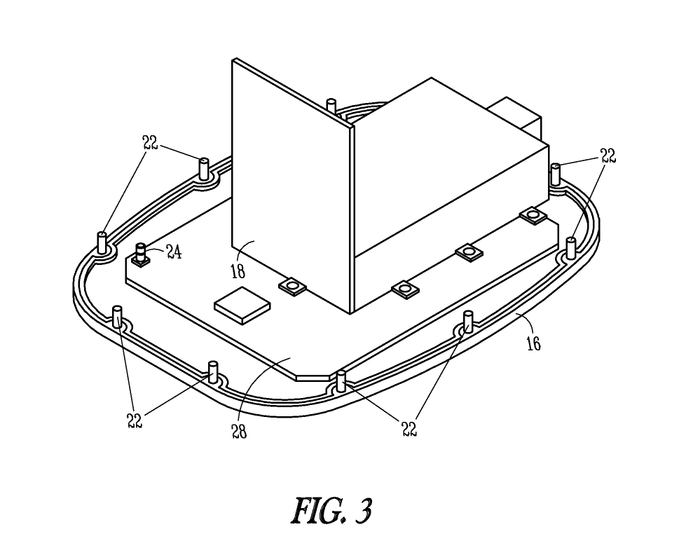

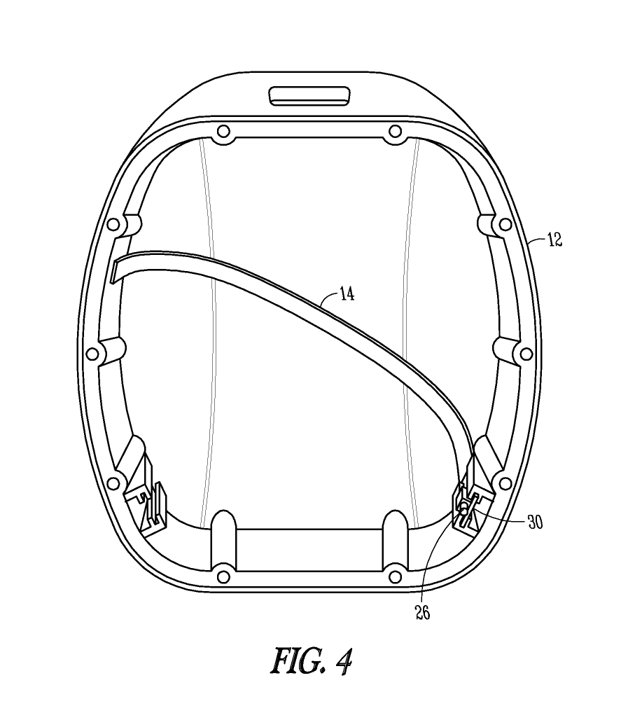

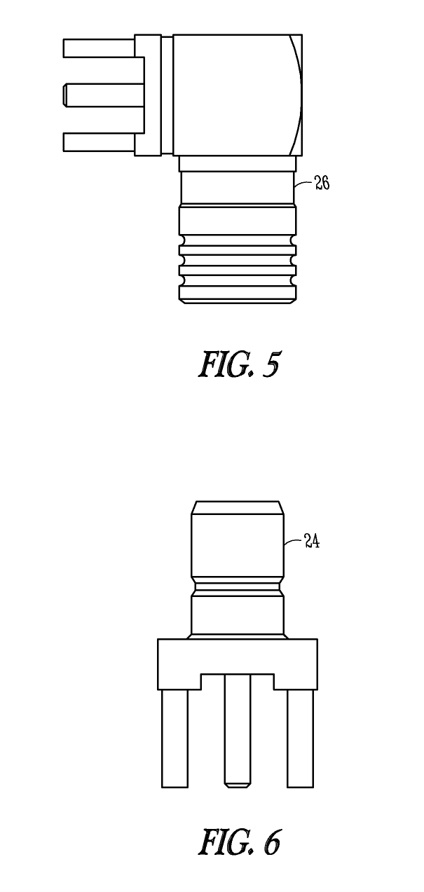

As shown in FIGS. 2 and 3, the satellite module 18 may include a circuit board 28 such that the first RF connector 24 is secured to the circuit board 28. FIG. 2 shows where first RF connector 26 connects directly to the second RF connector 24, which is seated in a bracket 30 that is attached to the inside the cover 12.

In some embodiments, the antenna 14 is an RF antenna that is mounted only inside the enclosure 20. In other embodiments, the antenna 14 may be mounted partially inside and partially outside the enclosure 20. In addition, the enclosure 20 may be a NEMA 4 rated water-proof enclosure (among other types of enclosures).

The direct connection between the antenna 14 and the satellite module 18 replaces a previously used RF cable thereby eliminating the problems associated with RF cable (i.e., imprecise length and cable movement). In addition, the direct connection design provides a precisely controlled and more accurately tuned antenna 14.

The Abstract is provided to comply with 37 C.F.R. §1.72(b) to allow the reader to quickly ascertain the nature and gist of the technical disclosure. The Abstract is submitted with the understanding that it will not be used to interpret or limit the scope or meaning of the claims.

What is claimed is:

1. A satellite assembly comprising:
a cover;
an antenna attached to the cover;
a base; and
a satellite module attached to the base such that the antenna is connected to the satellite module when the cover is secured to the base to form a sealed enclosure.

2. The satellite assembly of claim 1, wherein the cover is snapped to the base.

3. The satellite assembly of claim 1, wherein the antenna is secured to the cover with an adhesive.

4. The satellite assembly of claim 1, wherein the base is secured to the satellite module with fasteners.

5. The satellite assembly of claim 1, wherein the antenna includes a first RF connector and the satellite module includes a second RF connector that is connected to the first RF connector.

6. The satellite assembly of claim 5, wherein the first RF connector is a SMB RF connector and the second RF connector is a SMB RF connector.

7. The satellite assembly of claim 5, wherein the satellite module includes a circuit board and a connector secured to the circuit board such that the antenna is secured to the connector.

8. The satellite assembly of claim 1, wherein the antenna is an RF antenna.

9. The satellite assembly of claim 1, wherein the antenna is inside the enclosure.

10. The satellite assembly of claim 1, wherein the enclosure is a NEMA 4 type enclosure.
